(19) United States
(12) Patent Application Publication
(10) Pub. No.: US 2007/0174116 A1
(43) Pub. Date: Jul. 26, 2007

(54) Electronic coupon systems and methods to operate the same

(76) Inventors: Chad Christopher Keith, Saint Louis, MO (US); David Lee Dunmire, San Antonio, TX (US); Jeff Paul Clark, San Antonio, TX (US); Brian Michael Novack, Saint Louis, MO (US)

Correspondence Address: HANLEY, FLIGHT & ZIMMERMAN, LLC, 150 S. WACKER DRIVE, SUITE 2100, CHICAGO, IL, 60606, US

(21) Appl. No.: 11/337,276

(22) Filed: Jan. 23, 2006

(51) Int. Cl. G06Q 30/00

(52) U.S. Cl. 705/14

(57) ABSTRACT

Electronic coupon systems and methods to operate the same are disclosed. A disclosed example coupon management system includes a processor to determine an applicable coupon for an item to be purchased, and a network interface to receive a coupon selection from a remotely located user device, and to send the coupon to a remotely located point-of-sale terminal, wherein the point-of-sale terminal is to identify the item to be purchased and to apply the identified coupon to the item to be purchased.

### FIELD OF THE DISCLOSURE

This disclosure relates generally to coupons and, more particularly, to electronic coupon systems and methods to operate the same.

### BACKGROUND

Paper coupons are in use today by millions of people. They are a form of advertising, an enticement to try new products, a reminder of an advertiser's product, etc. Currently, the consumer is expected to clip, acquire, index, sort, store, locate and/or carry their paper coupons to each point-of-sale (POS) location. Electronic coupons which are redeemable over the Internet and/or distributed via the Internet and redeemable at a brick and mortar POS terminal are also known.

### BRIEF DESCRIPTION OF THE DRAWINGS

FIG. 1 is a schematic illustration of an example electronic coupon system constructed in accordance with the teachings of the invention.

FIG. 2 illustrates an example manner of implementing the example user device of FIG. 1.

FIG. 3 illustrates an example manner of implementing the example point-of-sale (POS) terminal of FIG. 1.

FIGS. 4A, 4B, 5, 6A and 6B illustrate example methods of using the example electronic coupon system of FIG. 1

FIG. 7 illustrates an example coupon entry data structure for the example master coupon database of FIG. 1.

FIG. 8 illustrates example entries in the example user coupon database of FIG. 1.

FIGS. 9A and 9B are flowcharts representative of example machine readable instructions which may be executed to implement the example user device of FIG. 1.

FIGS. 10A and 10B are flowcharts representative of example machine readable instructions which may be executed to implement the example web server of FIG. 1.

FIG. 11 is a flowchart representative of example machine readable instructions which may be executed to implement the example point-of-sale (POS) terminal of FIG. 1.

FIG. 12 is a schematic illustration of an example processor platform that may be used and/or programmed to execute the example machine readable instructions represented by FIGS. 9A, 9B, 10A, 10B and/or 11 to implement the example user device, the example web server and/or the example point-of-sale (POS) terminal of FIG. 1, respectively.

### DETAILED DESCRIPTION

Electronic coupon systems and methods to operate the same are disclosed. A disclosed example coupon management system includes a processor to determine an applicable coupon for an item to be purchased, and a network interface to receive a coupon selection from a remotely located user device, and to send the coupon to a remotely located point-of-sale terminal, wherein the point-of-sale terminal is to identify the item to be purchased and to apply the identified coupon to the item to be purchased.

A disclosed example point-of-sale terminal includes an output device to provide an order number for a purchase of an item, and a network interface to provide an identification of the item to a remotely located coupon management system and to receive a coupon to be applied to the purchase of the item, wherein the coupon is selected via a portable user device. An example user device includes a wireless transceiver to communicate with a remote coupon management system, and a user interface to allow a user of the user device to identify a purchase, review a first coupon applicable to the purchase, and select a second coupon to be applied to the purchase, wherein the purchase is performed at a point-of-sale terminal, and wherein the point-of-sale terminal and the user device are physically separate devices.

A disclosed example method includes locating an electronic yellow page directory entry, wherein the electronic yellow page directory entry identifies at least one electronic coupon, and transmitting a representation of the electronic coupon to user device.

Another disclosed example method includes providing a subscriber identifier to a remotely located coupon management system, receiving a purchase identifier from a point-of-sale terminal, receiving information regarding at least one coupon applicable to a purchase, and sending at least one coupon selection to the remotely located coupon management system. A further disclosed example method includes receiving an identifier of a purchaser, determining a coupon applicable to an item to be purchased based on the identifier, displaying the applicable coupon to the purchaser via a user device, and identifying the coupon to a point-of-sale terminal. Yet another disclosed example method includes identifying a location of a user device and receiving a coupon based on the location of the user device from a coupon store associated with the location. In the disclosed example methods, the point-of-sale terminal, the user device and the coupon management system are physically separate devices.

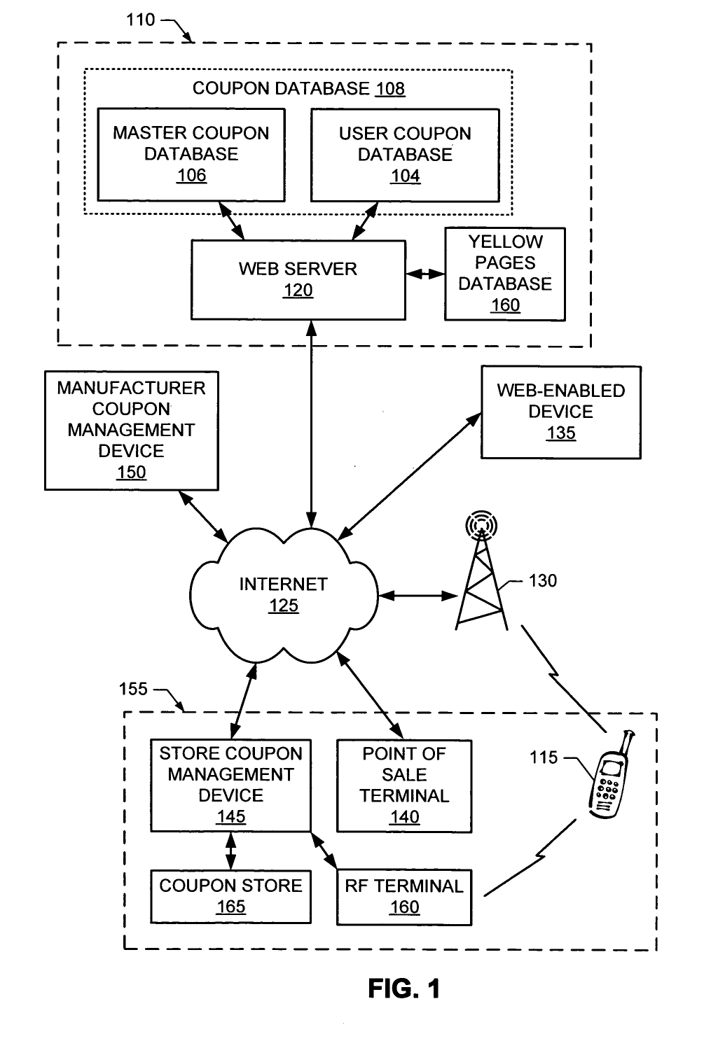

FIG. 1 is a schematic illustration of an example electronic coupon system. In the illustrated example of FIG. 1, coupons associated with a plurality of users are electronically stored in a user coupon database 104 associated with a coupon management system 110. The user coupon database 104 specifies, among other things, individualized list(s) of coupons available to each user to apply to purchases. As used herein, the term “available coupons” refers to the coupons currently associated with a user (e.g., present in a user's coupon account) and, thus, available to be applied to a purchase made by the user.

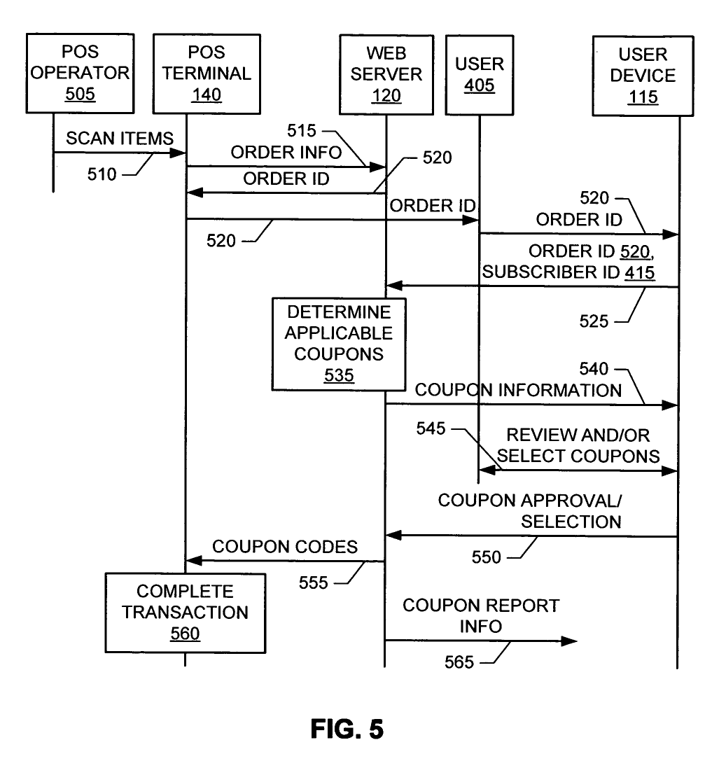

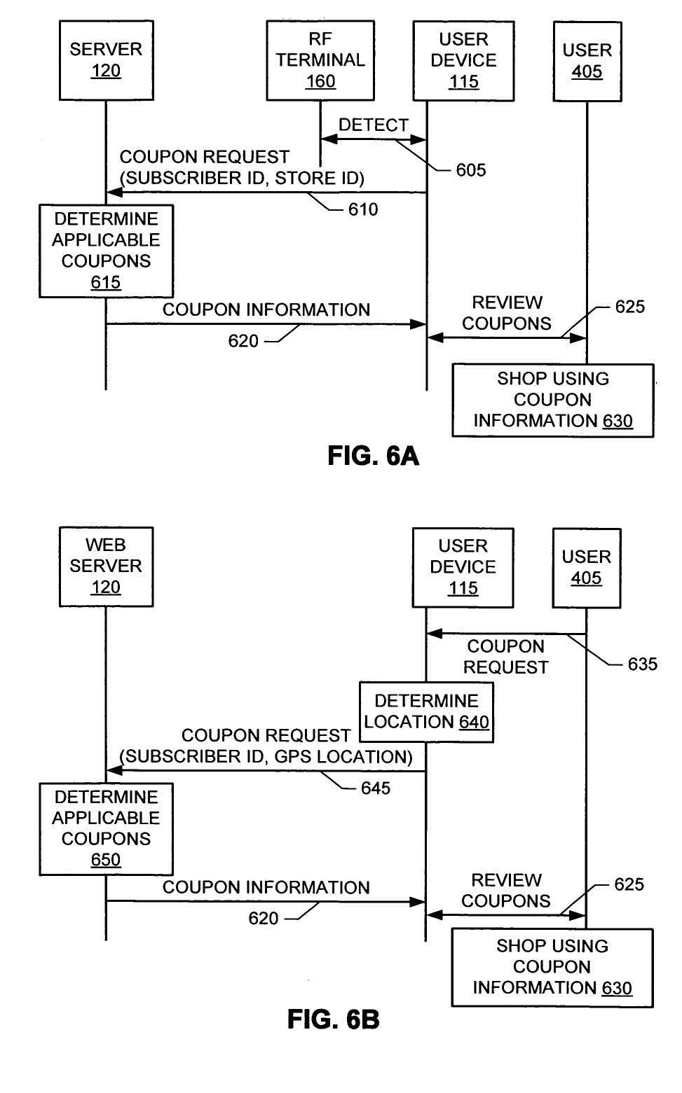

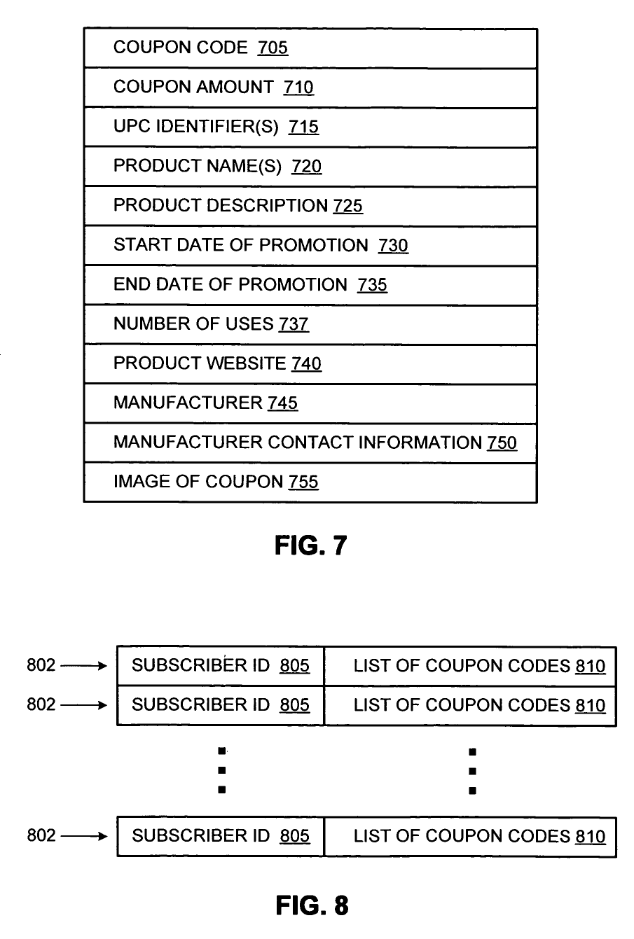

To store information regarding all manufacturer and/or retailer coupons, the example electronic coupon system of FIG. 1 includes a master coupon database 106. As discussed below in connection with FIGS. 4A and 4B, coupons from the master coupon database 106 may be obtained, searched for and/or added to a user's coupon account (i.e., a user's list of available coupons) stored in the user coupon database 104. Example methods of using the example electronic coupon system of FIG. 1 to locate and/or apply a user's available coupons to a purchase are discussed below in connection with FIGS. 5, 6A and 6B.

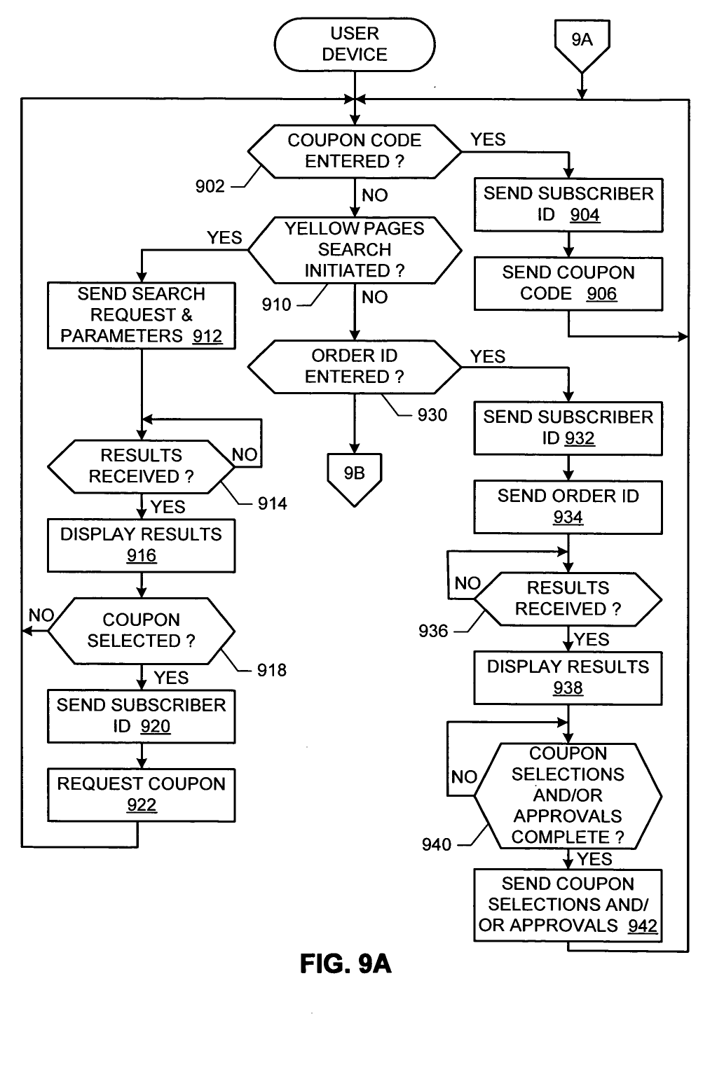

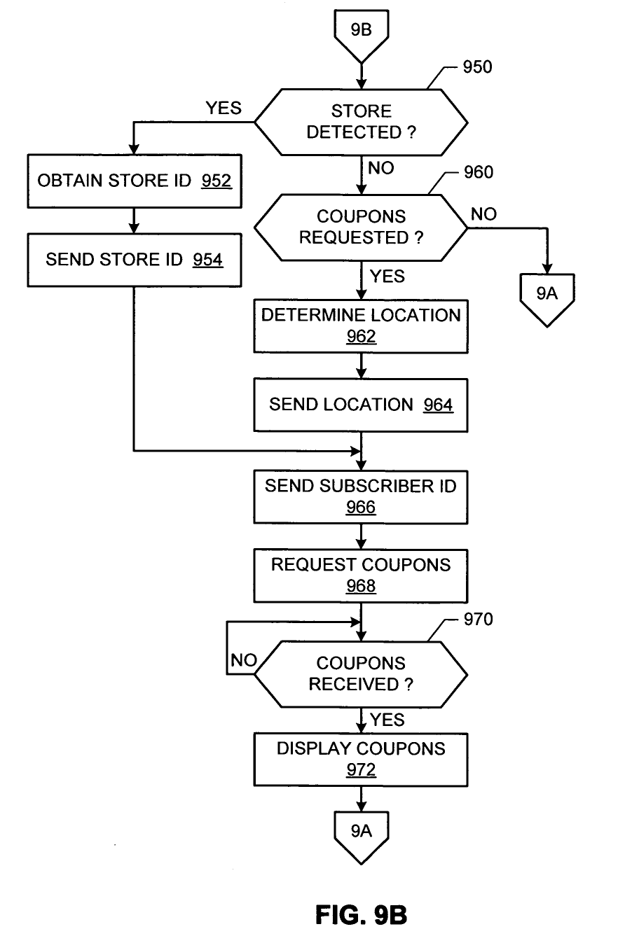

The example user coupon database 104 and the example master coupon database 106 may be implemented using any variety and/or number of databases and/or data structures. Additionally, the user coupon database 104 and/or the master coupon database 106 may be implemented separately or may be implemented together as a single coupon database 108. An example master coupon database 106 coupon entry is discussed below in connection with FIG. 7. Example user coupon database 104 entries are discussed below in connection with FIG. 8.

In the example electronic coupon system of FIG. 1, a user stores, accesses, indexes, locates, sorts and/or utilizes the user's available coupons via any variety of user device 115 capable of and/or configured to display information for a user of the example user device 115, and/or to provide a user interface and/or facilitate interactions between a user of the example user device 115 and the example coupon management system 110 and/or a radio frequency (RF) terminal 160. The example user device 115 communicates with any variety of web server(s) 120 implemented by and/or associated with the coupon management system 110. In the illustrated example, the example user device 115 communicates with the example web server 120 of FIG. 1 via an Internet-based network 125 by, for example, using a cellular communications network 130, a wireless fidelity (WiFi) access point, etc. The example user device 115 can be implemented by, for example, a web-enabled cellular phone, a web-enabled personal digital assistant (PDA), a wireless-enabled laptop, etc. The example user device 115 may also implement any variety of display capable to present and/or display coupon information but possibly not, in some examples, capable to receive user inputs and/or selections. Additionally, the user device 115 and/or any other variety of wired and/or wireless web-enabled device 135 (e.g., a personal computer) may be used to access the example web server 120 of FIG. 1 to add coupons to the user's coupon account, search for new and/or additional coupons to add to the user's coupon account, view the user's coupon account, view past coupons applied to purchases, remove unwanted coupons from the user's coupon account, etc. Further, the user device 115 and/or any other variety of wired and/or wireless web-enabled device 135 (e.g., a personal computer) may be used to access the example web server 120 of FIG. 1 to share, swap, trade and/or otherwise access and/or apply electronic coupons present in another user's coupon account.

To facilitate purchase one or more items, the example electronic coupon system of FIG. 1 includes a point-of-sale (POS) terminal 140. In the example electronic coupon system of FIG. 1, the example web server 120, the example user device 115 and the example POS terminal 140 are physically separate devices. Further, although for simplicity of illustration only one POS terminal 140 and one user device 115 are shown, the example electronic coupon system includes a plurality of user devices 115 and a plurality POS terminals 140 located at a plurality of potentially geographically disparate locations (e.g., stores). In the example of FIG. 1, the web server 120 (which may be implemented as one or more web servers 120) is a resource shared by the POS terminals 140. Further, the user devices 115 are associated (e.g., purchased, leased, etc.) with the subscribers of the example coupon management system 110 who are also purchasers of items at one or more of the POS terminals 140.

In the illustrated example, before a given purchase is finalized at a POS terminal 140, the example POS terminal 140 of FIG. 1 provides information identifying the items to be purchased to the example web server 120 via, for example, the Internet 125. For instance, in the illustrated example, a universal product code (UPC) for each item being purchased is provided to the web server 120. In response, the example web server 120 of FIG. 1 assigns an identifier (e.g., a number) to the given order (i.e., list of items to be purchased) and then provides the order identifier to the POS terminal 140.

To identify the coupon(s) that may be applied to the given order from the user's list of available coupons (i.e., the user's coupon account), the purchaser identifies him/herself to the web server 120 via, for example, the user device 115. An example identifier is a user identification (e.g., subscriber) number. The subscriber number may be stored by and/or within the user device 115. Additionally or alternatively, the subscriber number may be entered into a user interface provided by the user device 115 and/or via an input device associated with the user device 115. In the example electronic coupon system of FIG. 1, the user enters into and/or provides the order identifier to the example user device 115 of FIG. 1. Alternatively, the example user device 115 may be communicatively coupled to the POS terminal 140 and directly obtain the order identifier from the POS terminal 140. Together with the user identifier, the example user device 115 of FIG. 1 sends the order identifier to the web server 120 via, for example, the cellular communications network 130 and the Internet 125.

The example web server 120 of FIG. 1 queries the user coupon database 104 to determine if one or more coupons in the identified user's coupon account may be applied to the identified items to be purchased. In the illustrated example, the example web server 120 determines a desirable set of coupons to be applied to the purchases. In the illustrate example, the set of coupons is the set that results in the lowest overall purchase price for the identified order. Alternatively and/or in addition to accessing the user's list of available coupons stored in the user coupon database 104, the example web server 120 of FIG. 1 may search the master coupon database 104 to identify in-store coupons and/or in-store specials applicable to the identified order.

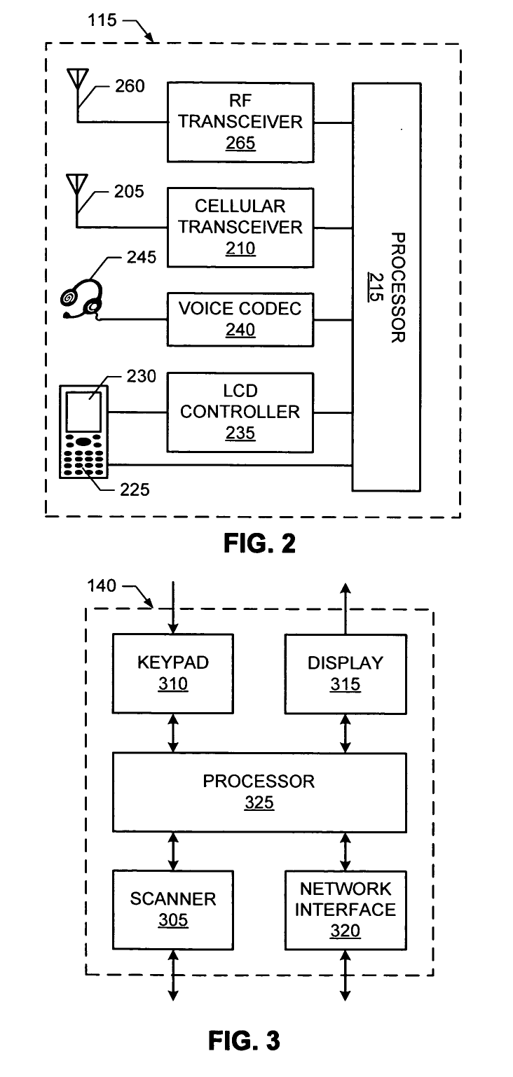

To allow the user to review the desirable set of coupons that could be applied to the identified order, the example web server 120 of FIG. 1 sends the applicable coupon information to the user device 115. For example, the web server 120 of FIG. 1 provides one or more web-based pages and/or web-based interfaces that the example user device 115 of FIG. 1 displays for the user. Via, for instance, any variety and/or number of user interfaces, the user reviews, selects, modifies and/or approves a list of coupons to be applied to the identified order. An example user interface is a web browser configured to display any variety and/or number of web pages provided by the web server 120 of FIG. 1 on the user device 115. As discussed below in connection with FIG. 2, the example user device 115 of FIG. 1 includes any variety of input device(s) to allow the user to provide inputs and/or selections, and any variety of output device(s) to display the user interface(s). Thus, in the illustrated example, coupon recommendations are displayed and/or coupon selections made on the user device 115 at the POS terminal 140 before the sales transaction is completed.

In the illustrated example of FIG. 1, after the list of applicable coupons is selected and/or approved, the example web server 120 of FIG. 1 provides the selected coupons to the POS terminal 140. For instance, the web server 120 of the illustrated example provides a coupon code (e.g., a UPC) for each coupon that is to be applied to the identified order. The example POS terminal 140 of FIG. 1 applies the coupon(s) identified by the web server 120 to the items being purchased in the same fashion as paper coupons provided by a purchaser are utilized. The purchase is then completed.

Based upon one or more parameters associated with a coupon, each applied coupon may be removed from the user's list of available coupons. Alternatively, if a coupon may be used more than once, the coupon may be left in the user's coupon account with, for example, a use count decremented. The example web server 120 of FIG. 1 also updates information in the master coupon database 106 to track usage information regarding each applied coupon. Example usage information includes date of use, location of use, additional items purchased, etc. Such usage information may be used by a manufacturer and/or store to, for instance, determine the marketing effectiveness of a coupon.

In the example electronic coupon system of FIG. 1, coupons may be offered to users using any of a variety of methods. For example, coupons may be postal mailed, electronically mailed, made available via web pages, made available via billboards, made available via yellow pages searches, etc. In the illustrated example, coupons are identified with a coupon code (e.g., a UPC). To allow manufacturers, advertisers and/or store owners to add, remove, modify and/or manage coupon stored in the master coupon database 106, the example electronic coupon system of FIG. 1 includes any variety and/or number of coupon management devices 145, 150. Example coupon management devices 145, 150 include any variety of computing devices and/or platforms (e.g., a personal computer) capable of interacting with the web server 120. Alternatively, the coupon management devices 145, 150 may implement any variety of propriety interface(s) with the example coupon management system 110 of FIG. 1.

The example coupon management devices 145, 150 of FIG. 1 may also be used by manufacturers, advertisers and/or store owners to retrieve and/or view usage statistics associated with their coupons. Example usage reports include lists of available coupons, expired coupons, number of customers who have used a particular coupon, number of customers who have added a particular coupon to their list of available coupons, related items that were purchased, etc.

To allow the example user device 115 of FIG. 1 to identify the example store (e.g., retailer, wholesaler, etc.) 155, the example store 155 of FIG. 1 includes one or more of any variety of RF terminals 160. The example RF terminal 160 of FIG. 1 implements, for instance, a WiFi access point that allows the user device 115 to, among other things, identify, for example, the name, location, address, etc. of the store 155. The example RF terminal 160 may also be used to communicatively couple the user device 115 to web server 120 via the Internet 125. The example RF terminal 160 of FIG. 1 may also be used to provide one or more files to the example user device 115 that the user device 115 may then display for the user via any variety of user interfaces (e.g., a web browser). In the illustrated example, the files transferred to the user device 115 include information on in-store coupons and/or in-store specials. For instance, the example store coupon management device 145 of FIG. 1 may access in-store coupon and/or in-store special information stored in, for example, a local coupon store 165. The store coupon management device 145 generates one or more image files (e.g., extensible markup language (XML) pages) containing the in-store coupon(s) and/or in-store special information, and the one or more image files are sent to the user device 115 via the RF terminal 160.

Additionally or alternatively, the example user device 115 of FIG. 1 may obtain coupons associated with the store 155 and/or the user by identifying the store 155 and/or the user directly to the web server 120. For instance, when entering a store 155, the user device 115 may detect the name and location of the store 155 via the RF terminal 160. The user device 115 may then automatically request coupon information for the identified store 155 by, for example, sending a coupon request to the web server 120. In response, the example web server 120 of FIG. 1 provides one or more image files (e.g., web pages) to the user device 115 containing a list of coupons that the user may be interested in and/or that may apply to items for sale in the store 155. For instance, the example web server 120 of FIG. 1 forwards coupons, from the user's coupon account and/or from the master coupon database 106, for items that are actually sold at the store 155. The forwarded coupons may be limited to only items that are actually available in the store 155. The forwarded coupons may include coupons from a competitor to the store 155 in which the user device 115 is located to enable the user to consider alternative shopping locations and/or to request the current store 155 to honor the competitor's coupon.

To allow a user (via the example user device 115 and/or the example web-enabled device 135) to identify coupons associated with yellow page directory entries, the example coupon management system 110 of FIG. 1 includes a yellow pages database 160. In the example of FIG. 1, a user may perform any variety of yellow page search(es) via the example user device 115 and/or the example user web-enabled device 135. In the illustrated example, the search results may return, in addition to phone numbers, addresses, websites, etc., information regarding one or more coupons and/or links to coupons offered by the identified businesses and/or persons. For example, a yellow page search may locate two florists and indicate that the first florist offers an electronic coupon. In the example system of FIG. 1, the yellow page search(es) may include the location of the example user device 115 and/or the identify coupons may depend upon the location. For instance, a coupon may be identified to a user if the user is near enough to a location such that the coupon might entice the user to immediately make a purchase based on the offered coupon. As described below in connection with FIGS. 4A-5, the user may add the coupon offered via the yellow pages search to their coupon account, and then apply the coupon to a subsequent purchase made at the first florist.

The yellow pages database 160 may be implemented using any variety and/or number of databases and/or data structures. For instance, existing yellow pages databases 160 may be updated and/or enhanced to include one or more coupon codes for any and/or all of the yellow page directory entries. In the example electronic coupon system of FIG. 1, the coupon codes included yellow page directory entries are linked back to coupon entries stored in the master coupon database 106. The entries are indexed based on coupon identifier codes. Alternatively, coupons associated with yellow page directory entries may be stored directly within the yellow page database 160 and accessed by the web server 120 from the yellow page database 160.

It will be readily apparent to persons of ordinary skill in the art that the POS terminal 140 and/or more generally, the example electronic coupon system of FIG. 1, may be implemented via virtually any variety of on-line store and/or on-line shopping site. For example, instead of the POS terminal 140 being used to physically scan items for purchase, the user may select and/or electronically place items to be purchased in a virtual and/or electronic shopping basket via any variety and/or number of web pages. In particular, the virtual POS terminal 140 may be any variety of web server which the user accesses via the Internet 125 using any of a variety of web-enabled communication device. During the subsequent checkout process, the virtual POS terminal 140, as described above, provides the list of items to be purchased to the web server 120 and then displays the received order identifier for the user on the user's user device 115. Alternatively, the user may review a list of coupons that may be applied to the order via a different web page on the same web-enabled communication device used to create the order or via a separate web-enabled communication device. The selection and application of coupons and completion of the sale may then proceed similarly to that described above, without requiring the user to enter a brick and mortar store 155.

FIG. 2 illustrates an example manner of implementing at least a portion of the example user device 115 of FIG. 1. To support wireless communications with a cellular communications network, the example user device 115 of FIG. 2 includes any of a variety of cellular antenna 205 and any of a variety of cellular transceiver 210. The example antenna 205 and the example cellular transceiver 210 of FIG. 2 are able to receive, demodulate and decode cellular signals transmitted to the example user device 115 by, for instance, the example cellular communications network 130 (FIG. 1). Likewise, the cellular transceiver 210 and the cellular antenna 205 are able to encode, modulate and transmit cellular signals from the example user device 115 to the cellular communications network 130.

To process received and decoded signals and to provide data for transmission, the illustrated example user device 115 of FIG. 2 includes a processor 215. The processor 215 may be any variety of processor such as, for example, a microprocessor, a microcontroller, a digital signal processor (DSP), an advanced reduced instruction set computing (RISC) machine (ARM) processor, etc. In general, the processor 215 executes machine readable instructions stored in a memory to control the example user device 115 of FIG. 2 and/or to provide one or more of a variety of user interfaces, applications, services, functionalities implemented and/or provided by the example user device 115 of FIG. 2.

In addition to handling receive and/or transmit data, the processor 215 may receive user inputs and/or selections, and/or provide any variety and/or number of user interfaces for a user of the example user device 115. For example, the processor 215 may receive inputs and/or selections made by a user via a keyboard 225, and/or provide a user interface on a display 230 (e.g., a liquid crystal display (LCD) 230) via, for instance, an LCD controller 235. Other example input devices include a touch screen, a mouse, etc. The display 230 may be used to display any of a variety of information such as, for example, a web browser, an application, menus, caller identification information, a picture, video, a list of telephone numbers, a list of video and/or audio channels, phone settings, etc.

To provide, for example, telephone services, the example user device 115 of FIG. 2 includes any of a variety of voice coder-decoder (codec) 240 and any variety of input and/or output devices such as, for instance, a jack for a headset 245. In particular, the processor 215 can receive a digitized and/or compressed voice signal from the headset 245 via the voice codec 240, and then transmit the digitized and/or compressed voice signal via the cellular transceiver 210 and the antenna 205 to the cellular communications network 130. Likewise, the processor 215 can receive a digitized and/or compressed voice signal from the cellular base station and output a corresponding analog signal via, for example, the headset 245 for listening by a user.

To support additional or alternative communication services, the example user device 115 of FIG. 2 may include any of a variety and/or number of RF antennas 260 and/or RF transceivers 265. An example RF antenna 260 and the example RF transceiver 265 support wireless communications based on the IEEE 802.11 (a.k.a., WiFi) standard. Additionally or alternatively, an RF transceiver 265 may support communications based on one or more alternative communication standards and/or protocols. Alternatively, the cellular antenna 205 may be used by the RF transceiver 265. Further, a single transceiver may be used to implement both the cellular transceiver 210 and the RF transceiver 265.

In the illustrated example of FIG. 2, the processor 215 may use the RF transceiver 265 to communicate with, among other devices, a WiFi access point, the RF terminal 160 (FIG. 1), etc. For instance, the example RF transceiver 265 of FIG. 2 may be used to enable the example user device 115 to connect to the Internet 125 and/or the web server 120 via the RF terminal 160. The processor 215, the display 230 and the keypad 225 may implement, for example, a web-based user interface (e.g., a web browser) allowing a user of the example user device 115 to interact with, for instance, the example web server 120 of FIG. 1 as described above in connection with FIG. 1.

Although an example user device 115 has been illustrated in FIG. 2, user devices may be implemented using any of a variety of other and/or additional devices, components, circuits, modules, etc. Further, the, devices, components, circuits, modules, elements, etc. illustrated in FIG. 2 may be combined, re-arranged, eliminated and/or implemented in any of a variety of ways. For example, the user device 115 may be a wireless-enabled laptop where the antenna 205, the antenna 260, the cellular transceiver 210 and/or the RF transceiver 265 are implemented on any variety of PC card. In another example, the user device 115 does not include an input device to receive user inputs and/or selections, that is, the user device 115 is only capable to receive coupon information from the POS terminal 140 and/or the electronic coupons system 110 and to display the coupon information for review by a user. For simplicity and ease of understanding, the following discussion references the example user device 115 of FIG. 2, but any other user device could likewise be used in this role.

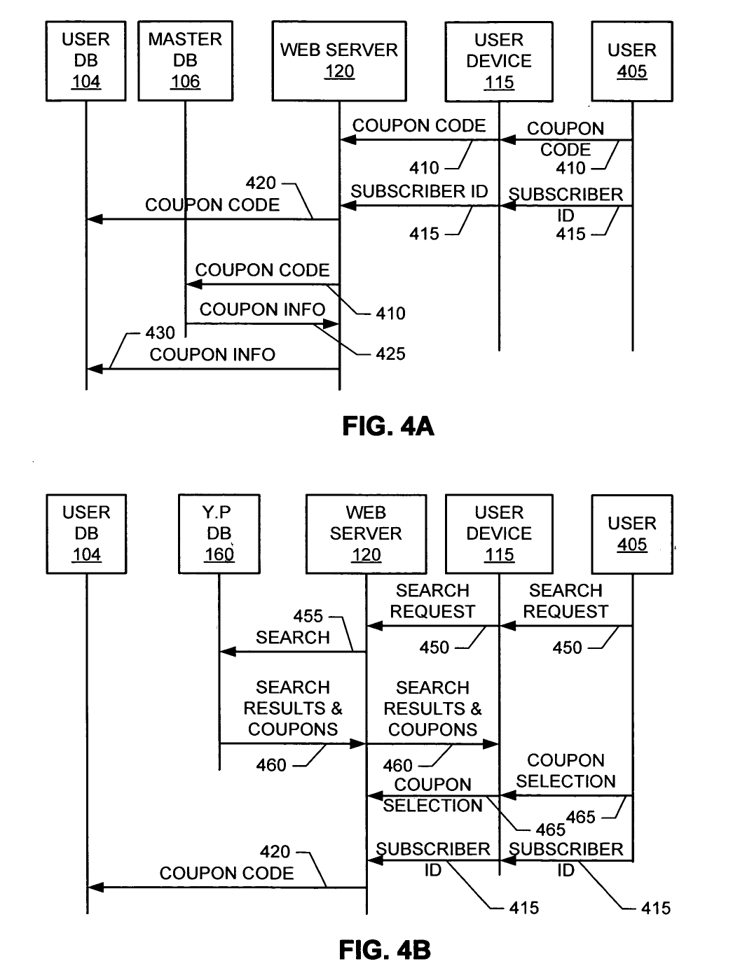

FIG. 3 illustrates an example manner of implementing at least a portion of the example POS terminal 140 of FIG. 1. To identify items to be purchased (e.g., to scan UPC bar codes of the items), the example POS terminal 140 of FIG. 3 includes any variety of optical UPC bar code scanner 305. Alternatively and/or additionally, an operator of the example POS terminal 140 may identify an item by entering, for example, a UPC code via a keypad or keyboard 310.

To display information regarding a purchase, the example POS terminal 140 of FIG. 3 includes any of a variety of displays 315. An example display 315 is used to display a list of items, that have been scanned and/or entered, for review by the purchaser and/or the operator of the POS terminal 140.

To allow the POS terminal 140 to exchange order information (e.g., UPCs), order identifiers and/or coupon information (e.g., coupon codes) with the example web server 120 of FIG. 1, the example POS terminal 140 of FIG. 3 includes any of a variety of network interfaces 320. The example network interface 320 of FIG. 3 communicatively couples the POS terminal 140 to the Internet 125, possibly via a local area network (LAN) implemented within the store 155. An example network interface 320 implements an Ethernet interface.

To control and/or operate the POS terminal 140, the example POS terminal 140 of FIG. 3 includes any of a variety of general purpose processors 325. The example processor 325 of FIG. 3 executes coded instructions present in a main memory of the processor 325. The processor 325 may be any type of processing unit, such as a microprocessor from the Intel®, AMD®, IBM®, or SUN® families of microprocessors. The processor 325 may implement, among other things, any portion of the example methods of using the example electronic coupon system of FIG. 1 illustrated herein by, for example, executing the example machine readable instructions illustrated herein.

Although an example POS terminal 140 has been illustrated in FIG. 3, POS terminals may be implemented using any of a variety of other and/or additional devices, components, circuits, modules, etc. Further, the, devices, components, circuits, modules, elements, etc. illustrated in FIG. 3 may be combined, re-arranged, eliminated and/or implemented in any of a variety of ways. For example, the POS terminal 140 may be a personal computer having a network interface 320 and a video graphics adapter, and communicatively coupled to a keyboard 310, a video display 315 and a scanner 305. For simplicity and ease of understanding, the following discussion references the example POS terminal 140 of FIG. 3, but any POS terminal could likewise be used in this role.

FIGS. 4A, 4B, 5, 6A and 6B illustrate example methods of operating and/or using the example electronic coupon system of FIG. 1. To facilitate understanding of the examples of FIGS. 4A-6B, corresponding elements in FIGS. 1-3 have been numbered with like reference numerals in FIGS. 4A-6B.

As discussed above in connection with FIGS. 1-3, interactions between a user 405, the user device 115 and the web server 120 in the examples illustrated in FIGS. 4A-6B may be implemented via any variety and/or number of user interfaces, web pages, web-based interfaces and/or web-based interactions. For example, web pages are provided by the web server 120 and displayed by the user device 115 for viewing by the user 405 in, for instance, a web browser implemented by the user device 115. Likewise, the user 405 may enter information and/or inputs into the user device 115 via, for example, the keypad 225. As is conventional, the entered inputs are passed through the user device 115 to the web server 120 as web browser user inputs.

FIGS. 4A and 4B illustrate example methods of operating the example electronic coupon system of FIG. 1 to locate and/or add coupons to a user's list of available coupons. That is, to add coupons to the user's coupon account located in the example coupon database 104 of FIG. 1. In the example method of FIG. 4A, the user 405 locates a coupon of interest and provides the corresponding coupon code 410 to the web server 120 via a web browser implemented by the user device 115. For example, the user 405 may locate the coupon in a print advertisement, on a web page, in a yellow pages directory, in an email, etc. The user 405 provides the coupon code 410 to the web server 120 by, for instance, entering the coupon code 410 into a web-based user interface provided via the display 230 and the keypad 225 (FIG. 2). Alternatively, the user device 115 may include and/or be communicatively coupled to any variety of optical scanner that can directly obtain the coupon code 410 from a printed coupon or advertisement.

The user 405 also provides the user's subscriber identifier 415 to the web server 120 via the web browser implemented by the user device 115. The subscriber identifier 415 may be any variety of alphanumeric characters. The user 405 provides the subscriber identifier 415 to the web server 120 by, for instance, entering the subscriber identifier 415 into a web-based user interface provided via the display 230 and/or the keypad 225 (FIG. 2).

In the illustrated example of FIG. 4A, the web server 120 adds the coupon code 410 to the list of coupons associated with the subscriber identifier 415 and stores the updated list of coupons in the user coupon database 104 as indicated with reference numeral 420. Additionally or alternatively, as also illustrated in FIG. 4A, the web server 120 locates and/or retrieves corresponding coupon information in the master coupon database 106 based upon the coupon code 410 as indicated with reference numeral 425. The web server 120 then updates the user's list of available coupons by updating the user coupon database 104 with the coupon information and/or adding an additional entry in the user coupon database 104 as indicated with reference numeral 430.

In the example method of FIG. 4B, the user 405 initiates an Internet-based yellow pages search 450 to locate a retail store, a service station, a professional, etc. In the illustrated examples of FIGS. 1 and 4B, the search request 450 is initiated via any variety of web-based yellow page search interface implemented by the web server 120 or any other web server and/or the user device 115. Based upon one or more parameters of the search request 450, the web server 120 performs a search of the yellow pages database 160 as indicated with reference numeral 455 and receives back search results and coupon information 460. The web server 120 subsequently provides the search results and coupon information 460 via one or more web pages for display by the user device 115.

If the user 405 selects a coupon from the web based display of search results and coupon information 460 as indicated with reference numeral 465, the user 405 and/or the user device 115 provides the user's subscriber identifier 415 to the web server 120. In the illustrated example of FIG. 4B, the web server 120, adds the coupon code of the selected coupon 465 to the list of coupons associated with the subscriber identifier 415 and stores the updated list of coupons in the user coupon database 104 as indicated with reference numeral 420.

FIG. 5 illustrates an example method of operating the example electronic coupon system of FIG. 1 to locate and apply coupons to a purchase made by the user 405. The example of FIG. 5 begins with an operator 505 of the POS terminal 140 scanning items to be purchased by the user 405 as indicated with reference numeral 510. When the operator 505 finishes scanning the items to be purchased, the POS terminal 140 sends a list of items 515 (i.e., order information) being purchased to the web server 120. In response, the web server 120 assigns and/or generates an order identifier 520 to the purchase and sends the order identifier 520 (e.g., an alphanumeric string) to the POS terminal 140.

In the illustrated example of FIG. 5, the POS terminal 140 displays and/or otherwise provides the order identifier 520 to the user 405 who. As described above, the user 405 then enters the order identifier 520 into the user device 115, which in turn, provides the order identifier 520 and the subscriber identifier 415 to the web server 120 as indicated with reference numeral 525. For example, the user 405 may enter the order identifier 520 and the subscriber identifier 415 into an interface (e.g., a web page) displayed on the user device 115. Alternatively, the POS terminal 140 and the user device 115 may be communicatively coupled and the user device 115 may obtain the order identifier 520 directly from the POS terminal 140 without user inputs.

Based on the order identifier 520 and the subscriber identifier 415, in the example of FIG. 5, the web server 120 determines and/or selects coupons from the user's list of available coupons that are applicable to the identified purchase (block 535). For example, the web server 120 queries the user coupon database 104 to determine which coupons in the user's coupon account could be applied and then determines the set of coupons that results in the lowest overall purchase price.

The web server 120 provides the compiled coupon information 540 identifying the determined and/or selected coupons via one or more interfaces (e.g., web pages) to the user device 115. The user device 115 displays the one or more interfaces for the user 405. In the example of FIG. 5, the user 405 reviews and/or selects coupons by reviewing the one or more interfaces as indicated with reference numeral 545. When the user 405 completes reviewing and/or selecting coupons, the user device 115 sends the coupon approval and/or selection information to the web server 120 as indicated with reference numeral 550.

The web server 120 provides a list of the selected and/or approved coupons 555 to the POS terminal 140. For instance, the web server 120 provides a coupon code (e.g., a UPC for the coupon) for each coupon that is to be applied to the identified purchase. The POS terminal 140 then applies the discount specified by each coupon identified by the web server 120 to the purchase and the purchase is completed (block 560).

In the example of FIG. 5, the web server 120 also updates information in the master coupon database 106 to track usage information regarding each applied coupon as indicated with reference numeral 565. Example usage information includes date, location, additional items purchased, etc. Such usage information 565 may be used, for instance, to determine the marketing effectiveness of the applied coupons and/or to summarize savings from the program to the user 405.

FIGS. 6A and 6B illustrate example methods of operating the example electronic coupon system of FIG. 1 to identify local in-store coupons and/or in-store specials. In the example of FIG. 6A, the user device 115 detects the RF terminal 160 as indicated with reference numeral 605. The user device 115 also determines and/or obtains a store and/or location identifier from the RF terminal 160. In the example of FIG. 6A, the user device 115 sends a coupon request 610 to the server 120. As illustrated, the user device 115 automatically sends the coupon request 610 once a store and/or location is identified. Alternatively, the user device 115 may send the coupon request 610 in response to a selection and/or entry made by the user 405. The example coupon request 610 of FIG. 6A includes the subscriber identifier 415 and the identifier for the store and/or location. The server 120 may be local to the store 155 (e.g., the store coupon management device 145) and/or may be coupled to the Internet 125 (e.g., the example web server 120 associated with the example coupon management system 110 of FIG. 1).

The server 120 determines applicable coupons based on the subscriber identifier 415 and/or the store identifier (block 615). The applicable coupons may include coupons from the user's list of available coupons stored in the user coupon database 104 and/or in-store coupons and/or in-store specials offered at the identified store and/or location. The server 120 sends information regarding the applicable coupons to the user device 115 via one or more interfaces (e.g., web pages) as indicated with reference numeral 620. The user device 115 displays the one or more interfaces for review by the user 405 as indicated with reference numeral 625. The user 405 may shop and/or select items for purchase based upon the displayed coupon information (block 630). In the illustrated example of FIG. 6B, the user device 115 is not required to receive user inputs and/or selections. At the POS terminal 140 any applicable coupons may be applied by, for example, implementing the example method discussed above in connection with FIG. 5.

Instead of, or in addition to, requesting and receiving coupon information from the server 120, the user device 115 may receive information regarding in-store coupons and/or in-store specials via the RF terminal 160. For example, the RF terminal 160 having detected the user device 115 may request from the store coupon management device 145 in-store coupons and/or in-store specials and provide them to the user device 115.

The illustrated example of FIG. 6B proceeds similarly to the example of FIG. 6A and, thus, descriptions of identical portions of the examples will not be repeated here. Instead, the interested reader is referred back to the discussion of FIG. 6A. To facilitate ease of understanding, identical portions of the examples of FIGS. 6A and 6B have been identified with like reference numerals.

In the example of FIG. 6B, the user 405 selects and/or otherwise indicates to the user device 115 that the user 405 is interested in applicable coupons that may be applied to purchases at the current location as indicated with reference numeral 635. In the example of FIG. 6B, the user device 115 uses an embedded, communicatively coupled and/or attached position location device to determine the current location of the user device 115 (block 640). An example position location device is a Global Positioning Satellite (GPS) receiver.

In the example of FIG. 6B, the user device 115 sends a coupon request 645 to the web server 120. The example coupon request 645 of FIG. 6B includes the subscriber identifier 415 and the current location information. The web server 120 determines, based on the subscriber identifier 415 and/or the current location information, applicable coupons (block 650). The applicable coupons may include coupons from the user's list of available coupons stored in the user coupon database 104 and/or in-store coupons and/or in-store specials offered at the store identified by the current location information.

FIG. 7 illustrates an example coupon entry data structure for the example master coupon database 106 of FIG. 1. The example coupon entry of FIG. 7 includes a coupon code field 705 that contains the coupon code for the coupon. In the example electronic coupon system of FIG. 1, coupons are located and/or indexed in the master coupon database 106 based on the coupon code field 705. Alternatively, coupons may be located based upon any other coupon entry field. The example coupon entry of FIG. 7 also includes:
(a) a coupon amount field 710 that indicates the discount and/or percentage savings applied to a purchase when the coupon is used;
(b) a UPC identifier(s) field 715 that lists UPC code(s) of products to which the coupon may be applied;
(c) a product name(s) field 720 that lists the name(s) of product(s) to which the coupon may be applied;
(d) a product description field 725 that describes the product(s) to which the coupon may be applied;
(e) a start of promotion date field 730 that specifies the earliest date the coupon may be used;
(f) an end of promotion date field 735 that specifies the latest date the coupon may be used;
(g) a number of uses field 737 that specifies the number of times the user may use the coupon;
(h) a product website field 740 that contains a link to a website to get further information regarding products to which the coupon may be applied;
(i) a manufacturer field 745 that provides the name of the company manufacturing the products to which the coupon may be applied;
(j) a manufacturer contact field 750 that provides, for example, a phone number for contacting the manufacturer; and
(l) an image of the coupon 755.

FIG. 8 illustrates example entries in the example user coupon database 104 of FIG. 1. As illustrated in FIG. 8, an example user coupon database 104 includes a plurality of entries 802. In the example of FIG. 8 each entry 802 includes a subscriber identifier 805 and a list of coupon codes 810 available to the subscriber identifier 805. That is, the list of coupon codes 810 represents the coupons currently in the user's coupon account. In the examples of FIG. 1, 7 and 8, coupon codes listed in the list of coupon codes 810 are the same coupon codes 705 (FIG. 7) used to identify and/or index coupons in the master coupon database 104.

In the example of FIG. 8, information regarding one of a user's available coupons 810 may be obtained by locating the user coupon database 104 entry 802 having the user's subscriber identifier 805, and by then accessing the corresponding list of coupon codes field 810. The coupon codes listed in the coupon codes field 810 may then be used to obtain the corresponding coupon information by cross-referencing the master coupon database 106.

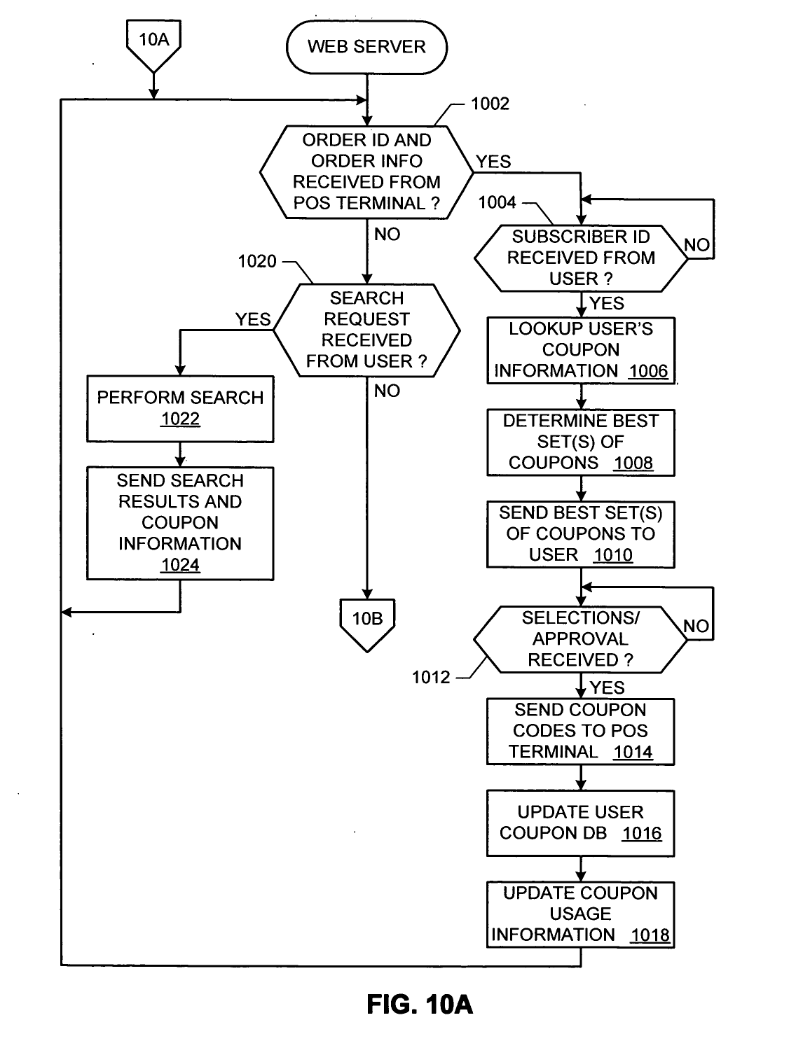

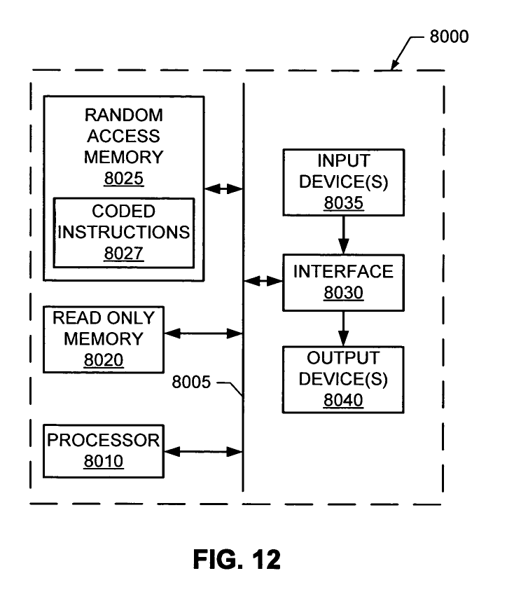

FIGS. 9A, 9B, 10A, 10B and 11 illustrate flowcharts representative of example machine readable instructions that may be executed to implement the example user device 115, the example web server 120, the example POS terminal 140 and/or, more generally, the example electronic coupon system of FIG. 1. The example machine readable instructions of FIGS. 9A-11 may be executed by a processor, a controller and/or any other suitable processing device. For example, the example machine readable instructions of FIGS. 9A-11 may be embodied in coded instructions stored on a tangible medium such as a flash memory, or random access memory (RAM) associated with a processor (e.g., the processor 8010 shown in the example processor platform 8000 and discussed below in conjunction with FIG. 12). Alternatively, some or all of the example flowcharts of FIGS. 9A-11 may be implemented using an application specific integrated circuit (ASIC), a programmable logic device (PLD), a field programmable logic device (FPLD), discrete logic, hardware, firmware, etc. Also, some or all of the example flowcharts of FIGS. 9A-11 may be implemented manually or as combinations of any of the foregoing techniques, for example, a combination of firmware, software and/or hardware. Further, although the example machine readable instructions of FIGS. 9A-11 are described with reference to the flowcharts of FIGS. 9A-11, persons of ordinary skill in the art will readily appreciate that many other methods of implementing the example user device 115, the example web server 120, the example POS terminal 140 and/or, more generally, the example electronic coupon system of FIG. 1 may be employed. For example, the order of execution of the blocks may be changed, and/or some of the blocks described may be changed, eliminated, sub-divided, or combined. Additionally, persons of ordinary skill in the art will appreciate that the example machine readable instructions of FIGS. 9A-11 be carried out sequentially and/or carried out in parallel by, for example, separate processing threads, processors, devices, circuits, etc.

The example machine readable instructions of FIGS. 9A and 9B begin with user device 115 checking if a coupon code was entered by a user (block 902). If a coupon code was entered (block 902), the user device 115 sends the user's subscriber identifier to the web server 120 (block 904) and sends the coupon code to the web server 120 (block 906). Control then returns to block 902.

If a coupon code was not entered (block 902), the user device 115 determines if the user initiated a yellow pages search (block 910). If the user initiated a yellow pages search (block 910), the user device 115 sends a request to search the web yellow pages directory 160 (block 912). In the examples of FIGS. 1, 4B, and 9A, the user initiates a yellow pages search by provided one or more parameters via a web-based interface (e.g., a web page) and selecting, for example, a button provided in a web page to initiate the search.

The user device 115 then waits to receive yellow pages search results from, for example, the web server 120 (block 914). When search results are received (block 914), the user device 115 displays the search results (block 916). If the user, while reviewing the displayed search results, selects a coupon associated with one of the search results (block 918), the user device sends the user's subscriber identifier to the web server 120 (block 920) and sends the coupon code of, or otherwise identifies, the selected coupon to web server 120 (block 922). Control then returns to block 902. If at block 918, the user does not select a coupon, control returns to block 902. The determination that the user has not selected a coupon may be made when, for example, a countdown timer expires, the user requests a different web page, etc.

Returning to block 910, if the user has not initiated a yellow pages search, the user device 115 determines if the user entered an order identifier (block 930). If the user did not enter an order identifier (block 930), control proceeds to block 950 of FIG. 9B. If the user did enter an order identifier (block 930), the user device 115 sends the user's subscriber identifier to the web server 120 (block 932) and sends the entered order identifier to the web server 120 (block 934).

The user device 115 then waits to receive coupon information from the web server 120 (block 936). When coupon information is received from the web server 120 (block 936), the user device 115 displays the coupon information (block 938) and waits for the user to complete coupon selections and/or coupon approvals (block 940). When the user has completed making coupon selections and/or coupon approvals (block 940), the user device 115 sends the coupon selections and/or approvals to the web server 120 (block 942). Control then returns to block 902.

Continuing at block 950 of FIG. 9B, the user device 115 determines if a store (e.g., an RF terminal) was detected (block 950). If a store was detected (block 950), the user device 115 obtains information identifying the store (e.g., a store name) (block 952) and then sends the identifying information to the web server 120 (block 954). Control then proceeds to block 966.

Returning to block 950, if the user device 115 does not detect a store, the user device 115 determines if the user has requested coupons for the current location (block 960). If the user has not requested coupons for the current location (block 960), then control returns to block 902 of FIG. 9A. If the user has requested coupons for the current location (block 960), the user device 115 determines via any variety of device and/or technique the current location of the user device 115 (block 962) and sends the current location information to the web server 120 (block 964). Control then proceeds to block 966.

At block 966, the user device 115 sends the user's subscriber identifier to the web server 120. The user device 115 then sends a coupon request to the web server 120 (block 968) and waits to receive coupon information from the web server 120 (block 970). When coupon information is received from the web server 120 (block 970), the user device 115 displays the coupon information for the user (block 972). Control then returns to block 902 of FIG. 9A.

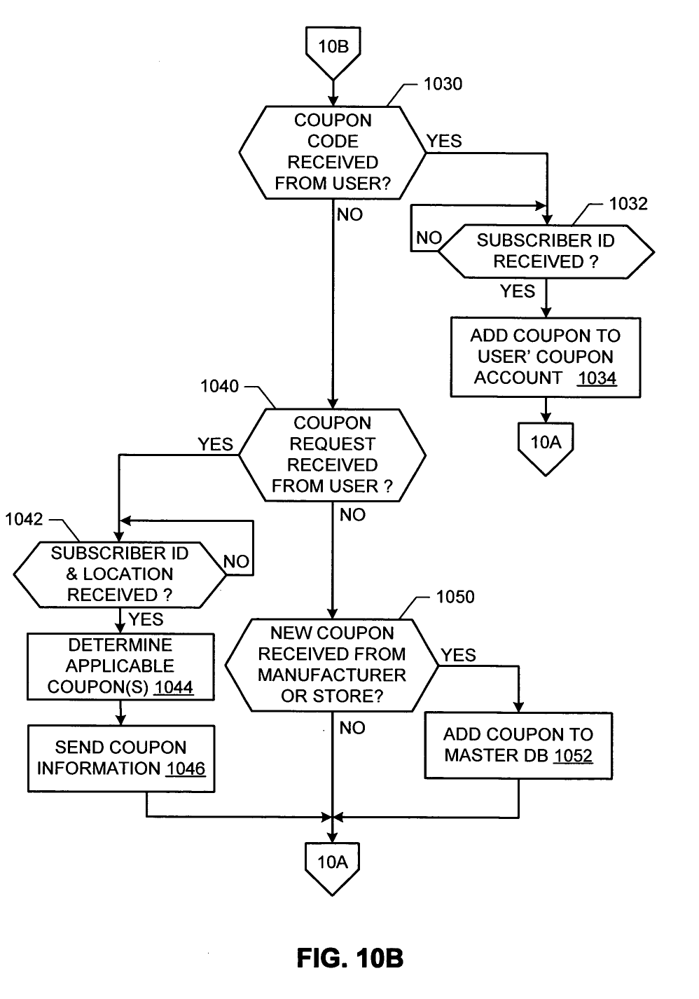

The example machine readable instructions of FIGS. 10A and 10B begin with web server 120 determining if an order identifier was received from a POS terminal 140 (block 1002). If an order identifier was received (block 1002), the web server 120 waits to receive a subscriber identifier from the purchaser (block 1004). When the subscriber identifier is received (block 1004), the web server 120 looks up the subscriber's coupon information in the user coupon database 104 (block 1006) and determines a best set of coupons to apply to the purchase (block 1008). The web server 120 sends information regarding the best set of coupons to the purchaser (block 1010) and waits to receive coupon selections and/or approvals from the purchaser (block 1012). When final coupon selections and/or approvals are received from the purchaser (block 1012), the web server 120 sends the coupons codes of the selected and/or approved coupons to the POS terminal 140. Then web server 120 updates the user coupon database 104 (block 1016) and updates coupon usage statistics and/or information in the master coupon database 106 (block 1018). Control then returns to block 1002.

If an order identifier was not received (block 1002), the web server 120 determines if a search request was received (e.g., a yellow pages search request) (block. 1020). If a search request was not received (block 1020), control proceeds to block 1030 of FIG. 10B. If a search request was received (block 1020), the web server 120 performs the search (block 1022) and provides the search results and coupon information to the user (block 1024). Control then returns to block 1002.

At block 1030 of FIG. 10B, the web server 120 determines if a coupon code was received from a user. If a coupon code was received (block 1030), the web server 120 waits to receive the user's subscriber identifier (block 1032). When the user's subscriber identifier is received (block 1032), the web server 120 updates the user coupon database 104 to add the coupon code to the user's list of available coupons (block 1034). Control then returns to block 1002 of FIG. 10A.

Returning to block 1030, if the web server 130 did not receive a coupon code, the web server 120 determines if a coupon request was received from a user (block 1040). If coupon request was received (block 1040), the web server 120 waits to receive the user's subscriber identifier and the current location of the user (block 1042). The current location of the user may identify a store, current coordinates of the user, etc. When the subscriber identifier and the current location information are received (block 1042), the web server determines the coupons applicable to the current location and/or the user by, for example, cross-referencing a database correlating coupons to location and/or user (block 1044). The web server 120 sends information regarding the applicable coupons to the user (block 1046) and control returns to block 1002 of FIG. 10A.

Returning to block 1040, if a coupon request is not received, the web server 120 determines if a new manufacturer or store coupon was received (block 1050). If a new coupon was not received (block 1050), control returns to block 1002 of FIG. 10A. If a new coupon was received (block 1050), the new coupon is added to the master coupon database 106 (block 1052). Control then returns to block 1002 of FIG. 10A.

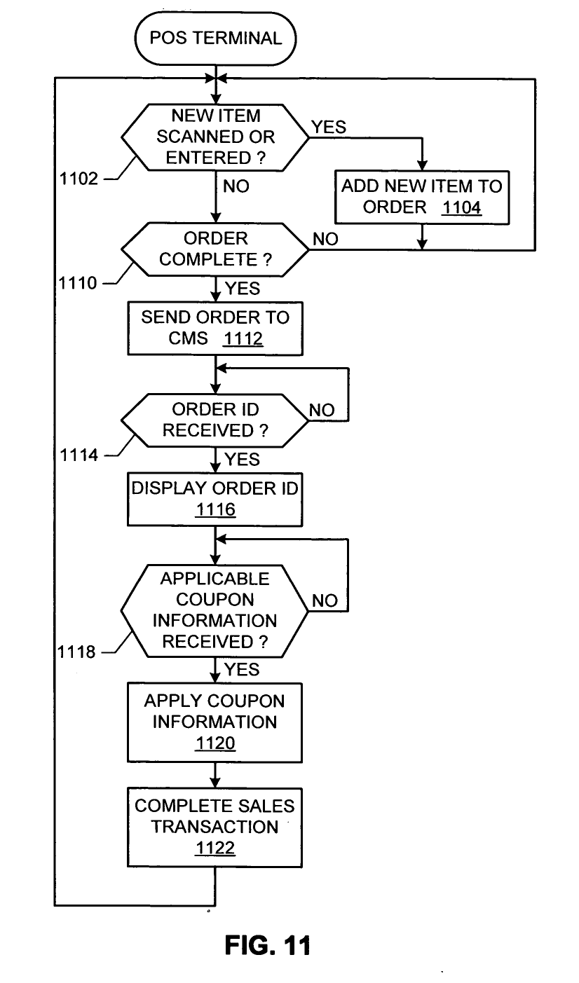

The example machine readable instructions of FIG. 11 begin with the POS terminal 140 determining if a new item was scanned or entered (block 1102). If a new item was scanned or entered (block 1102), the new item is added to the order (block 1104). Control then returns to block 1102.

If a new item was not scanned or entered (block 1102), the POS terminal 140 determines if the order is complete (i.e., the last item scanned or entered) (block 1110). If the last item has not been scanned or entered (block 1110), control returns to block 1102. If the order is complete (block 1110), the POS terminal 140 sends the list of scanned and/or entered items to the web server 120 (block 1112) and waits to receive an order identifier from the web server 120 (block 1114). When the order identifier is received (block 1114), the POS terminal 140 displays and/or otherwise provides the order identifier to the user (e.g., via electronic transmission) (block 1116) and waits to receive coupon information and/or coupon codes from the web server 120 or a message indicating no coupons can be applied (block 1118). When the coupon information and/or coupon codes are received (block 1118), the POS terminal 140 applies the coupons (if any) to the order (block 1120) and completes the purchase transaction (block 11222). Control then returns to block 1102.

FIG. 12 is a schematic diagram of an example processor platform 8000 that may be used and/or programmed to implement the example user device 115, the example web server 120, the example POS terminal 140 and/or, more generally, the example electronic coupon system of FIG. 1. For example, the processor platform 8000 can be implemented by one or more general purpose microprocessors, microcontrollers, etc.

The processor platform 8000 of the example of FIG. 12 includes a general purpose programmable processor 8010. The processor 8010 executes coded instructions 8027 present in main memory of the processor 8010 (e.g., within a RAM 8025). The processor 8010 may be any type of processing unit, such as a microprocessor from the Intel®, AMD®, IBM®, or SUN® families of microprocessors. The processor 8010 may implement, among other things, the example methods illustrated in FIGS. 4A-6B and/or the example machine readable instructions of FIGS. 9A-11 to implement the example user device 115, the example web server 120, the example POS terminal 140 and/or, more generally, the example electronic coupon system of FIG. 1.

The processor 8010 is in communication with the main memory (including a read only memory (ROM) 8020 and the RAM 8025) via a bus 8005. The RAM 8025 may be implemented by dynamic random access memory (DRAM), Synchronous DRAM (SDRAM), and/or any other type of RAM device, and ROM may be implemented by flash memory and/or any other desired type of memory device. Access to the memory 8020 and 8025 is typically controlled by a memory controller (not shown) in a conventional manner.

The processor platform 8000 also includes a conventional interface circuit 8030. The interface circuit 8030 may be implemented by any type of well-known interface standard, such as an external memory interface, serial port, general purpose input/output, etc.

One or more input devices 8035 and one or more output devices 8040 are connected to the interface circuit 8030. The input devices 8035 and output devices 8040 may be used, for example, to implement interfaces between the POS terminal 140 and the Internet 130; between the user device 115 and the cellular communication network 130 and/or the RF terminal 160; between the web server 120 and the user coupon database 104, the master coupon database 106, the yellow pages database 160 and/or the Internet 125; etc.

Of course, persons of ordinary skill in the art will recognize that the order, size, and proportions of the memory illustrated in the example systems may vary. Additionally, although this patent discloses example systems including, among other components, software or firmware executed on hardware, it will be noted that such systems are merely illustrative and should not be considered as limiting. For example, it is contemplated that any or all of these hardware and software components could be embodied exclusively in hardware, exclusively in software, exclusively in firmware or in some combination of hardware, firmware and/or software. Accordingly, persons of ordinary skill in the art will readily appreciate that the above described examples are not the only way to implement such systems.

At least some of the above described example methods and/or apparatus are implemented by one or more software and/or firmware programs running on a computer processor. However, dedicated hardware implementations including, but not limited to, an ASIC, programmable logic arrays and other hardware devices can likewise be constructed to implement some or all of the example methods and/or apparatus described herein, either in whole or in part. Furthermore, alternative software implementations including, but not limited to, distributed processing or component/object distributed processing, parallel processing, or virtual machine processing can also be constructed to implement the example methods and/or apparatus described herein.

It should also be noted that the example software and/or firmware implementations described herein are optionally stored on a tangible storage medium, such as: a magnetic medium (e.g., a disk or tape); a magneto-optical or optical medium such as a disk; or a solid state medium such as a memory card or other package that houses one or more read-only (non-volatile) memories, random access memories, or other re-writable (volatile) memories; or a signal containing computer instructions. A digital file attachment to e-mail or other self-contained information archive or set of archives is considered a distribution medium equivalent to a tangible storage medium. Accordingly, the example software and/or firmware described herein can be stored on a tangible storage medium or distribution medium such as those described above or equivalents and successor media.

To the extent the above specification describes example components and functions with reference to particular devices, standards and/or protocols, it is understood that the teachings of the invention are not limited to such devices, standards and/or protocols. Such systems are periodically superseded by faster or more efficient systems having the same general purpose. Accordingly, replacement devices, standards and/or protocols having the same general functions are equivalents which are intended to be included within the scope of the accompanying claims.

Although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

1. A coupon management system comprising:
a processor to determine an applicable coupon for an item to be purchased; and
a network interface to receive a coupon selection from a remotely located user device, and to send the coupon to a remotely located point-of-sale terminal, wherein the point-of-sale terminal is to identify the item to be purchased and to apply the identified coupon to the item to be purchased.

2. A coupon management system as defined in claim 1, further comprising:
a master coupon database to store coupon information; and
a user coupon database to store coupon information associated with a user.

3. A coupon management system as defined in claim 1, wherein the user coupon database identifies a coupon in the master coupon database.

4. A coupon management system as defined in claim 1, further comprising a yellow pages directory, wherein the yellow pages directory identifies a coupon associated with a directory entry.

5. A coupon management system as defined in claim 4, wherein the coupon is added to the user coupon database when the user performs a yellow pages search that identifies the directory entry.

6. A coupon management system as defined in claim 1, wherein the server is configured to at least one of:
accept a user input to add a new coupon from the master database to the user coupon database;
accept a user input to view the applicable coupon, wherein the applicable coupon is stored in the user coupon database;
accept a user input to select the applicable coupon;
accept a user input to add a coupon to the master coupon database;
accept a user input to view information regarding coupon usage;
to receive the identification of the item being purchased; or
to provide the applicable coupon.

7. A coupon management system as defined in claim 1, wherein the point-of-sale terminal comprises:
an output device to provide an order number for a purchase of an item; and
a network interface to provide an identification of the item to the coupon management system and to receive a coupon to be applied to the purchase of the item, wherein the coupon is selectable via the user device by a person making the purchase.

8. A coupon management system as defined in claim 1, wherein the user device comprises:
a wireless transceiver to communicatively couple the user device with a coupon management system; and
a user interface to allow a user of the user device to identify a purchase, review a coupon applicable to the purchase, and select a coupon to be applied to the purchase, wherein the purchase is performed at a point-of-sale terminal.

9. A point-of-sale terminal comprising:
an output device to provide an order number for a purchase of an item; and
a network interface to provide an identification of the item to a remotely located coupon management system and to receive a coupon to be applied to the purchase of the item, wherein the coupon is selectable via a portable user device.

10. A point-of-sale terminal as defined in claim 9, further comprising a scanner to identify the item to be purchased.

11. A point-of-sale terminal as defined in claim 9, wherein the output device is to display the order number for the person.

12. A point-of-sale terminal as defined in claim 9, wherein the output device is a radio frequency device that communicates the order number to the user device.

13. A point-of-sale terminal as defined in claim 9, wherein the coupon is an electronic coupon.

14. A point-of-sale terminal as defined in claim 9, wherein the portable user device and the point-of-sale terminal are physically separate devices.

15-20. (canceled)

21. A method comprising:
providing a subscriber identifier to a remotely located coupon management system;
receiving a purchase identifier from a point-of-sale terminal;
receiving information regarding at least one coupon applicable to a purchase; and
sending at least one coupon selection to the remotely located coupon management system.

22. A method as defined in claim 21, further comprising sending the purchase identifier to the coupon management system.

23. A method as defined in claim 21, wherein at least one of providing the subscriber identifier, receiving the information regarding the at least one coupon, or sending the at least one coupon selection is performed via an Internet-based connection.

24-30. (canceled)

31. A method comprising:
receiving an identifier of a purchaser;
determining a coupon applicable to an item to be purchased based on the identifier;
displaying the applicable coupon to the purchaser via a user device; and
identifying the coupon to a point-of-sale terminal, the point-of-sale terminal and the user devices being physically separate devices.

32. A method as defined in claim 31, further comprising receiving an identifier of the item to be purchased from the point-of-sale terminal.

33. A method as defined in claim 31, wherein determining the coupon comprises selecting a coupon having a pre-determined characteristic from a plurality of coupons associated with the identified purchaser.

34. A method as defined in claim 31, further comprising receiving a selection of the applicable coupon from the user device.

35-43. (canceled)

44. An article of manufacture storing machine readable instructions which, when executed, cause a machine to:
receive an identifier of a purchaser;
determine a coupon applicable to an item to be purchased based on the identifier;
display the applicable coupon to the purchaser via a user device; and
identify the coupon to a point-of-sale terminal, the point-of-sale terminal and the user devices being physically separate devices.

45. An article of manufacture as defined in claim 44, wherein the machine readable instructions, when executed, cause the machine to receive an identifier of the item to be purchased from the point-of-sale terminal.

46. An article of manufacture as defined in claim 44, wherein the machine readable instructions, when executed, cause the machine to determine the coupon by selecting a coupon having a pre-determined characteristic from a plurality of coupons associated with the identified purchaser.
